(19) United States
(12) Patent Application Publication
(10) Pub. No.: US 2018/0160252 A1
(43) Pub. Date: Jun. 7, 2018

(54) PRE-PROVISIONING OF A DEVICE

(71) Applicant: Microsoft Technology Licensing, LLC, Redmond, WA (US)

(72) Inventors: Kyle M. Olive, Redmond, WA (US); Jason R. Farmer, Snohomish, WA (US); Torsten Stein, Snohomish, WA (US)

(21) Appl. No.: 15/369,746

(22) Filed: Dec. 5, 2016

(51) Int. Cl. H04W 4/00; H04L 29/08; H04W 8/20

(52) U.S. Cl. CPC H04W 4/001; H04L 67/303; H04L 67/10; H04W 4/005; H04W 8/205

(57) ABSTRACT

Configuration information can be associated with a device (and unique device ID) at a point of sale location. At the point of sale location, the device can be associated with a user's account in a cloud system via unique ID. Configuration information for the device can then be provided through the users associated cloud account to a device's cloud based provisioning and configuration account. When the device is powered up, the device can pull provisioning and/or configuration information from the associated cloud account which can be identified by the device's unique ID.

### BACKGROUND

Consumer electronic devices typically require configuration before first-time use. For example, many consumer electronic devices interface with wireless networks and must be configured with the network ID and password before connection with the wireless network. One example is in a home network that includes Internet of Things (IoT) devices. Configuration of such devices can be cumbersome since many such devices do not have a dedicated keyboard. The configured process may also require additional steps by the user including downloading of device specific applications. This can delay the out-of-the-box experience and challenges to first-time use of the device.

### SUMMARY

A secure and automated system can be used to provision devices with configuration information. A temporary connection can be used to access configuration information from a cloud server. A unique device ID can be provided to the cloud server and the configuration information may be downloaded to the device. For example, a wireless network ID and password can be downloaded to configure the device for a wireless network. This avoids the requirement for the configuration information to be directly input into the device.

Configuration information can be associated with a device (and unique device ID) at a point of acquisition or transfer location. The point of acquisition or transfer location may also be referred to herein as a point of sale location. At the point of acquisition location, the device can be associated with a user's account in a cloud-based system via the unique device ID. Configuration information for the device can then be provided through the user's associated cloud-based account to a device's cloud-based provisioning and configuration account. When the device is powered up, the device can pull provisioning and/or configuration information from the associated cloud account which can be identified by the device's unique ID.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with accompanying drawings wherein:

FIG. 1 is a network diagram that illustrates an example cloud computing system that can be used to implement disclosed embodiments.

FIG. 2 shows an example non-limiting server or computer that can be used implement disclosed embodiments.

FIG. 3 shows a system for automatically provisioning a device, such as a consumer electronic device.

FIG. 4A is a flow chart that illustrates operation from the viewpoint of device.

FIG. 4B is a flow chart that illustrates operation from the viewpoint of a cloud server or configuration service.

FIG. 5 illustrates an example of one embodiment of a system for automatic configuration.

FIG. 6 is a flow chart that illustrates operation from the viewpoint of a cloud server or cloud service.

### DETAILED DESCRIPTION OF ILLUSTRATIVE EMBODIMENTS

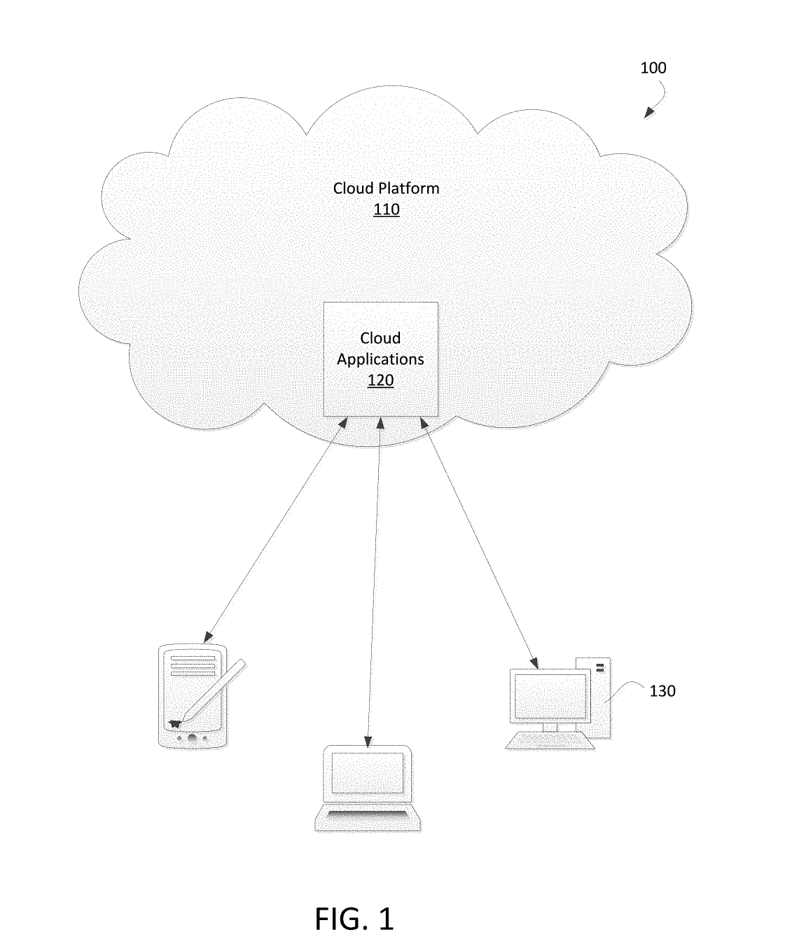

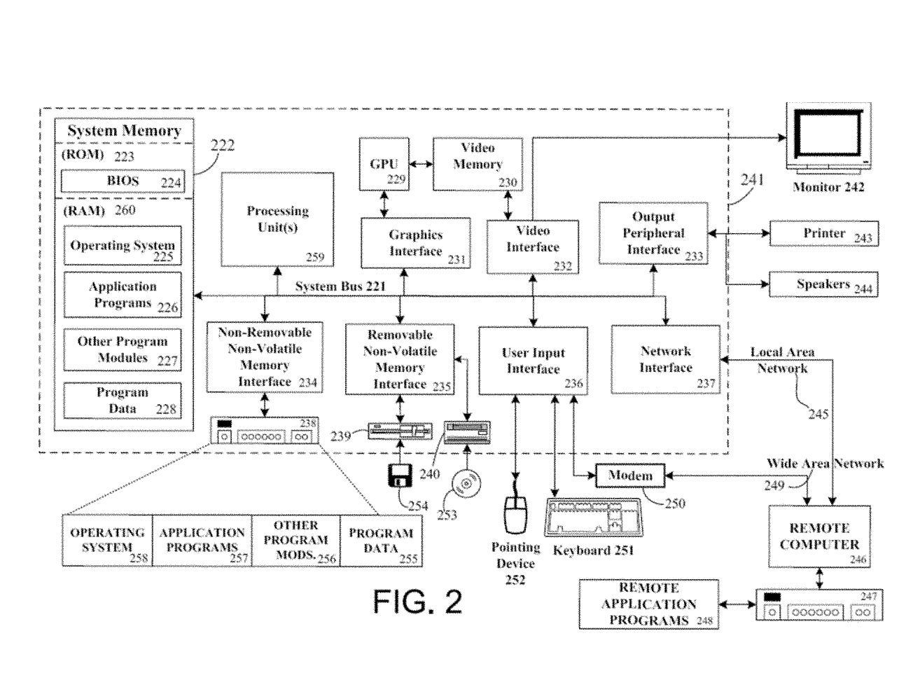

FIGS. 1 and 2 illustrate example devices and architectures that can be used with the embodiments of the present disclosure.

FIG. 1 is a network diagram that illustrates an example cloud-based computing system 100. In an embodiment, the computing system 100 shown in FIG. 1 is merely illustrative and is not intended to suggest any limitation as to scope or functionality. Embodiments of the disclosure are operable with numerous other configurations. With reference to FIG. 1, the computing system 100 includes a cloud computing platform 110, cloud applications 120, and client devices 130.

The cloud computing platform 110 may be configured to execute cloud-based applications 120 requested by the client devices 130. The cloud computing platform 110 may maintain computing devices that provide virtual machines, which execute the cloud application 120. The cloud computing platform may also include storage resources that store applications and system information. The cloud computing platform 110 may connect to the client devices 130 via a communications network, such as a wireless network, local area network, wired network, or the Internet.

The cloud applications 120 are available to the client devices 130. The software executed on the cloud computing platform 110 implements the cloud applications 120. In one embodiment, virtual machines provided by the cloud computing platform 110 execute the cloud applications 120. The cloud applications 120 may include, but are not limited to, editing applications, network management applications, finance applications, or any application requested or developed by the client devices 130. In certain embodiments, some functionality of the cloud application 120 may be executed on the client devices 130.

The client devices 130 may be utilized by a user to interact with cloud applications 120 provided by the cloud computing platform 110. The client devices 130, in some embodiments, register with the cloud computing platform 110 to access the cloud applications 120. Any client device 130 with an account from the cloud computing platform 110 may access the cloud applications 120 and other resources provided in the cloud computing platform 110. The client devices 130 may include, without limitation, personal digital assistants, smart phones, laptops, personal computers, gaming systems, set-top boxes, or any other suitable client computing device. The client devices 130 may include user and system information storage to store user and system information on the client devices 130. The user information may include search histories, cookies, and passwords. The system information may include internet protocol addresses, cached Web pages, and system utilization. The client devices 130 communicate with the cloud computing platform 110 to receive results from the cloud applications 120.

Accordingly, the computing system 100 is configured with a cloud computing platform 110 that provides cloud applications 120 to the client devices 130. The cloud applications 120 remove the burden of updating and managing multiple local client applications on the client devices 130.

FIG. 2 illustrates an example non-limiting server or computer 202 that can implement disclosed embodiments. Such a server or computer can be used to implement cloud computing as well as the methods described below.

In FIG. 2, the computing environment 220 comprises a computer 241, which typically includes a variety of computer readable media. Computer readable media may be any available media that may be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 2 illustrates operating system 225, application programs 226, other program modules 227, and program data 228.

The computer 241 may also include other removable/non-removable, volatile/nonvolatile computer storage media. By way of example only, FIG. 2 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above provide storage of computer readable instructions, data structures, program modules and other data for the computer 241. In FIG. 2, for example, hard disk drive 238 is illustrated as storing operating system 258, application programs 257, other program modules 256, and program data 255. Note that these components may either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, which may take the form of a mouse, trackball, or touch pad, for instance. Other input devices (not shown) may include a microphone, joystick, game pad, satellite dish, scanner, or the like. These and other input devices are often connected to the processing unit 259 through a user input interface 236 that is coupled to the system bus 221, but may be connected by other interface and bus structures, such as a parallel port, game port or a universal serial bus (USB). A monitor 242 or other type of display device is also connected to the system bus 221 via an interface, such as a video interface 232, which may operate in conjunction with a graphics interface 231, a graphics processing unit (GPU) 229, and/or a video memory 229. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2 illustrates remote application programs 248 as residing on memory device 247. It will be appreciated that the network connections shown are illustrative and other means of establishing a communications link between the computers may be used.

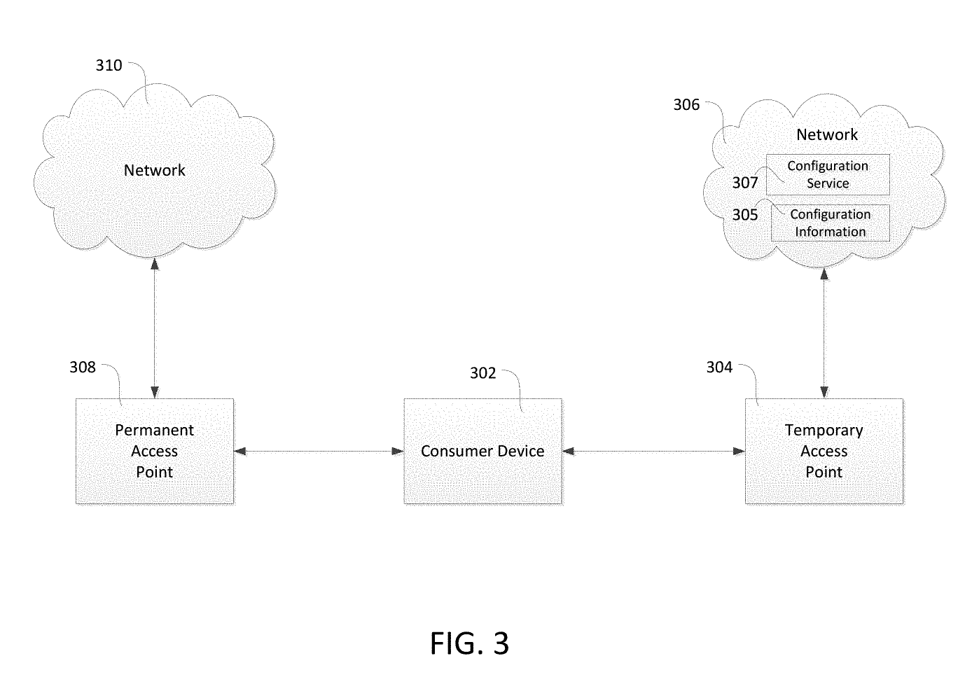

FIG. 3 illustrates an example system for automatically provisioning a device 302, such as a consumer electronic device. In one embodiment, device 302 may include functionality, such as wireless access capability, that needs to be configured.

The consumer electronic device can be any device, such as a TV, sensor, appliances (including ovens, refrigerators, washer/dryers), printer, thermostat, home alarm/security system, lighting unit, heating or air conditioning system, and actuators including door locks.

In one example, the consumer electronic device may be an IoT device. In an IoT network, physical devices or user equipment embedded with electronics, sensors, software and network connectivity are able to collect and exchange information with one another. In various embodiments, the disclosure may be practiced in a machine-to machine (M2M), Internet of Things (IoT), or Web of Things (WoT) communication system. Generally, M2M technologies provide building blocks for the IoT/WoT, and any M2M device, gateway or service platform may be a component of the IoT/WoT as well as an IoT/WoT service layer, etc.

The M2M/IoT/WoT communication system may include a communication network which may be a fixed network, e.g., Ethernet, Fiber, ISDN, PLC, or the like or a wireless network, e.g., WLAN, cellular, or the like, or a network of heterogeneous networks. For example, the communication network may include multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network may comprise other networks such as a core network, the Internet, a mesh network including a sensor network and personal area network, an industrial control network, a satellite network, a home network, or an enterprise network.

An example device 302 may include one or more of a processor, a transceiver, a transmit/receive element, a speaker/microphone, a keypad, a display/touchpad/indicator(s), non-removable memory, removable memory, a power source, a global positioning system (GPS) chipset, and other peripherals. It will be appreciated that the device may include any sub-combination of the foregoing elements while remaining consistent with an embodiment.

The processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal coding, data processing, power control, input/output processing, and/or any other functionality that enables the device to operate in a wireless environment. The processor may be coupled to the transceiver, which may be coupled to the transmit/receive element. The processor may perform application-layer programs, e.g., browsers, and/or radio access-layer (RAN) programs and/or communications. The processor may perform security operations such as authentication, security key agreement, and/or cryptographic operations, such as at the access-layer and/or application layer for example.

The transmit/receive element may be configured to transmit signals to, or receive signals from, a service platform. For example, in an embodiment, the transmit/receive element may be an antenna configured to transmit and/or receive RF signals. The transmit/receive element may support various networks and air interfaces, such as WLAN, WPAN, cellular, and the like. In an embodiment, the transmit/receive element may be an emitter/detector configured to transmit and/or receive IR, UV, or visible light signals, for example. In yet another embodiment, the transmit/receive element may be configured to transmit and receive both RF and light signals. It will be appreciated that the transmit/receive element may be configured to transmit and/or receive any combination of wireless or wired signals.

Systems and/or user equipment in a IoT environment may include, without limitation, a smartphone or other wireless communications device, a desktop and/or laptop computer system, a wearable computing device (e.g., a smartwatch, an activity and/or fitness monitoring device, etc.), a connected vehicle and/or systems associated with the same (e.g., a passenger vehicle, aircraft, boat, train, and/or telematics and/or infotainment systems associated with the same, etc.), a home automation and/or security system and/or components associated with the same (e.g., security keypads, networked locks, gate and/or other access control devices, connected lighting, etc.), connected thermostats, HVAC systems, irrigation systems, water controls, pumps, heaters, home utility meters, home network gateways, activity sensors, alarms (e.g., fire and/or CO2 alarms), a tablet computer, wireless control devices (e.g., keyless entry or remote start devices, etc.), gaming or other entertainment devices, connected home appliances (e.g., refrigerators, washing machines, ranges, toasters, etc.), consumer electronic devices (e.g., a bathroom scale, a digital camera, speaker systems, televisions, etc.), medical devices (e.g., pacemakers, insulin pumps, blood sugar monitors, etc.), and/or any other computing system and/or device as well as associated status and/or data stores.

An IoT network may further include one or more service provider systems that may communicate, directly or indirectly, with a variety of the systems and/or user equipment included in the IoT. In some embodiments, the one or more service provider systems may provide information to, and/or receive information from, the systems and/or devices (e.g., data collected by the systems and/or devices, control information for controlling the function and/or operation of the systems and/or devices, etc.). For example, a user may use a smartphone to interface with a service provider system associated with a home security company via network to control the state of a networked lock associated with his or her home security system. The user may further view information relating to a status and/or state of the networked lock from the service provider system.

The systems and/or devices may be communicatively coupled via one or more connections to the network. For example, a user may remotely communicate with a networked lock and/or an associated service provider system using a smartphone 102 via one or more network connections. In further embodiments, systems and/or devices in an personal IoT network may directly communicate without the use of any intermediate network connections (e.g., via a proximal field communication channel and/or the like).

The network connections may comprise a variety of network communication devices and/or channels and may use any suitable communications protocols and/or technologies for facilitating communication between the connected devices and systems. In some embodiments, the network connections may, for example, comprise the Internet, a local area network, a virtual private network, and/or any other communication network or combination of networks using one or more electronic communication technologies and/or standards (e.g., Ethernet or the like). The network connections may use multiplexers, routers, hubs, gateways, firewalls, switches and/or any other network communication devices and/or systems to facilitate communications on the networks. In some embodiments, the network connections may comprise a wireless carrier system such as a personal communications system.

In some embodiments, the network connections may comprise an analog mobile communications network and/or a digital mobile communications network using, for example, code division multiple access (“CDMA”), Global System for Mobile Communications or Group Special Mobile (“GSM”), frequency division multiple access (“FDMA”), and/or time divisional multiple access (“TDMA”) technologies. In certain embodiments, the network connections may incorporate one or more satellite communication links. In yet further embodiments, the network connections may use IEEE's 902.11 standards, Bluetooth®, ultra-wide band (“UWB”), Zigbee®, near field communications (NFC) technologies, and or any other suitable technology or technologies.

Device 302 may require configuration information, either for first-time use, continued use, or both. The configuration information can include home or personal configuration information. Examples of configuration information can include wireless network IDs and passwords, media streaming passwords, calendar information or the like. In one example, the device 302 may require a wireless network ID and password to connect to a network 310 through access point 308.

Many consumer devices do not have dedicated keyboards so that inputting such configuration information can be difficult and cumbersome. Current solutions typically require user interaction between the device 302 and the network 310 when first provisioning the device. Devices often use a remote or a display panel to allow a user to awkwardly input such configuration information which can take a substantial amount of time. Alternately, the user may be required to install device specific applications on a smart phone or tablet to execute this task, or use another control or master device to connect to the device 302 and enter the configuration information.

Referring to FIG. 3, temporary access point 304 can provide a temporary connection to devices such as device 302. The device 302 can access cloud data storage 306 to obtain the configuration information 305 (such as the wireless network ID and password for the access point 308). Temporary access point 304 can have an open channel for devices for the temporary connection. Temporary access point 304 can be, for example, part of a router, a dedicated server, or a device already on the network. In one embodiment, the temporary access point 304 and access point 308 can be combined into a single unit.

Temporary Access Point 304 can be used for configuring the device 302. Temporary Access Point 304 (either specifically used for this purpose, or as a service bundled into a secondary device like a router) can act as a single always-available shared and secured access point to the configuration service 307.

Temporary Access Point 304 can expose a shared internet connection that only provides limited access to the internet in the form of a secure connection to the configuration service. The Temporary Access Point 304 can be an open access point that the device 302 can detect and connect to automatically.

The network 306 can be used to provide access to the Configuration Service 307. The device 302 can obtain configuration information from the Configuration Service 307. Network 306 could be a wireless network, like an open WiFi access point, a hardline connection, or any variety of radios and network protocols (e.g., low power mesh).

In one embodiment, a password (associated with the device ID) may be provided to device 302. This password may be sent through temporary access point 304 to the Configuration Service 307 which then provides the configuration information 305 to device 302.

Configuration Service 307 can be a cloud application running on one or more cloud servers that are configured to provide the configuration information 305 to the device 302 once device 302 is authenticated with the password. Configuration Service 307 can use the device ID to look up the correct configuration information 305 as well as to determine how to test the password.

Network 310 can be the network that the device 302 should be on, once configured. Network 310 is not necessarily the same as the Configuration Network 306. Network 310 may be a completely different network using a completely different protocol and radio. Alternatively, a target network need not be used in some examples, and the device configuration information does not include connection information.

Device 302, on power up, can be configured to automatically detect the Temporary Access Point 304 (i.e., by unique SSID or other identifier (for low power networks)). The Device 302 can use Temporary Access Point 304 to call up to the configuration service and obtain configuration information securely.

Once configuration information is obtained, the device 302 can automatically apply the configuration information. If the configuration information includes network configuration, the device 302 can automatically connect to the target network 310 which may or may not be the same radio or protocol type as the configuration access point (Temporary Access Point 304).

The device 302 can then disconnect from Temporary Access Point 304 and is now configured. The configuration process can operate automatically without intervention from a user (or after the user merely providing a password).

Device 302 can maintain its own protocol for manual override and local configuration of a device, should that be deemed desirable, by implementing in parallel appropriate remote endpoints for configuration on an app-by-app basis.

Manual configuration of device 302 can supersede the automatic configuration discussed above to allow for user control of the system.

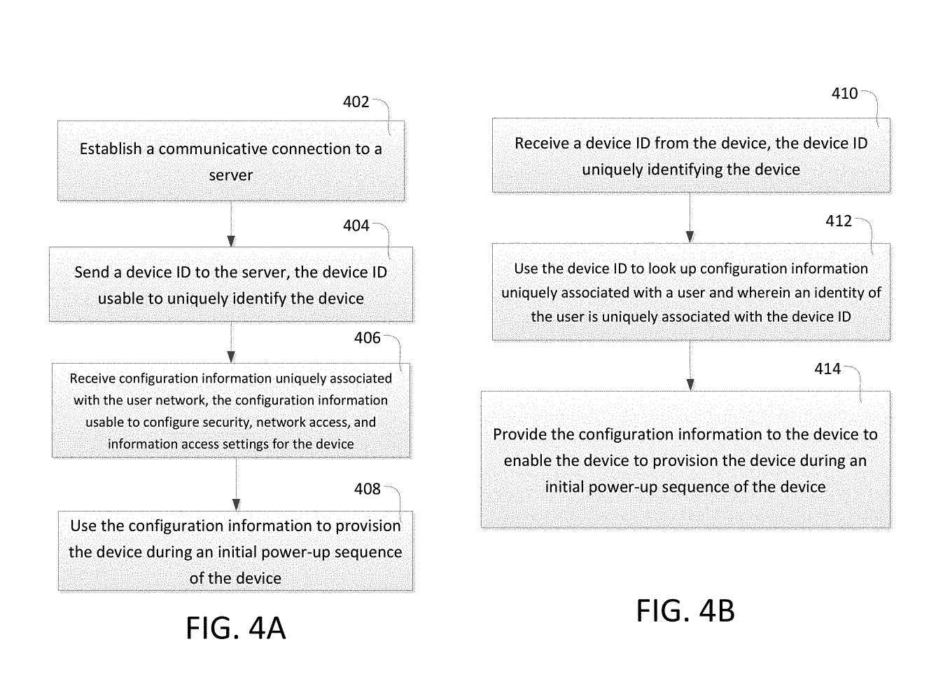

FIG. 4A is a flow chart that illustrates operations from the viewpoint of device 302.

In step 402, a communicative connection to a server is made. This can be a temporary or a limited connection to a cloud-based server through temporary access point 304.

In step 404, a device ID is sent to the server. The device ID can be usable to uniquely identify the device. The device ID can be sent through the temporary or limited connection with the temporary access point 304.

In step 406, configuration information is received from the server. The configuration information can be uniquely associated with a user or a user network. The identity of the user or the user network can be uniquely associated with the device ID. The configuration information may be usable to configure one or more of security, network access, and information access settings for the device based on security settings associated with the user network.

In step 408, the configuration information is used to provision the device during an initial power-up sequence of the device. In one example, the configuration information is used to make a connection to a wireless access point (such as permanent access point 308).

FIG. 4B is a flow chart that illustrates operation from the viewpoint of a cloud-based server or configuration service 307.

In step 410, data indicative of a device ID is received from a device, such as device 302. The device ID can be usable to uniquely identify an IoT device. The device ID may be received via a device transaction point. The device ID may be associated with a user account.

In step 412, the device ID is used to look up the configuration information. The configuration information can be uniquely associated with a user and the identity of the user can be uniquely associated with the device ID. The configuration information for the device may be associated with the user account. The configuration information may be usable to configure one or more of security, network access, and information access settings for the device

In step 414, the configuration information is provided to the device, such as device 302, to enable the device to provision the device during an initial power-up sequence of the device.

Many consumer devices are network-connected and typically need some amount of configuration before they can be used. Typically, the configuration and association with a user and the user's account is performed at first power up when the device is in the user's possession.

When powering up a device for the first time, a user typically needs to use the device's UI or a smart device such as a phone or tablet to connect to the new device and enter provisioning and configuration information so that the device can be used for its intended purpose. The process often requires several steps by the user including downloading of device specific applications on the device. This process can delay the out-of-the-box experience and present an unnecessary and challenging step to use the device for the first time. This results in a poor experience and may also leave the device exposed to unauthorized access between power up and the user finishing the device provisioning.

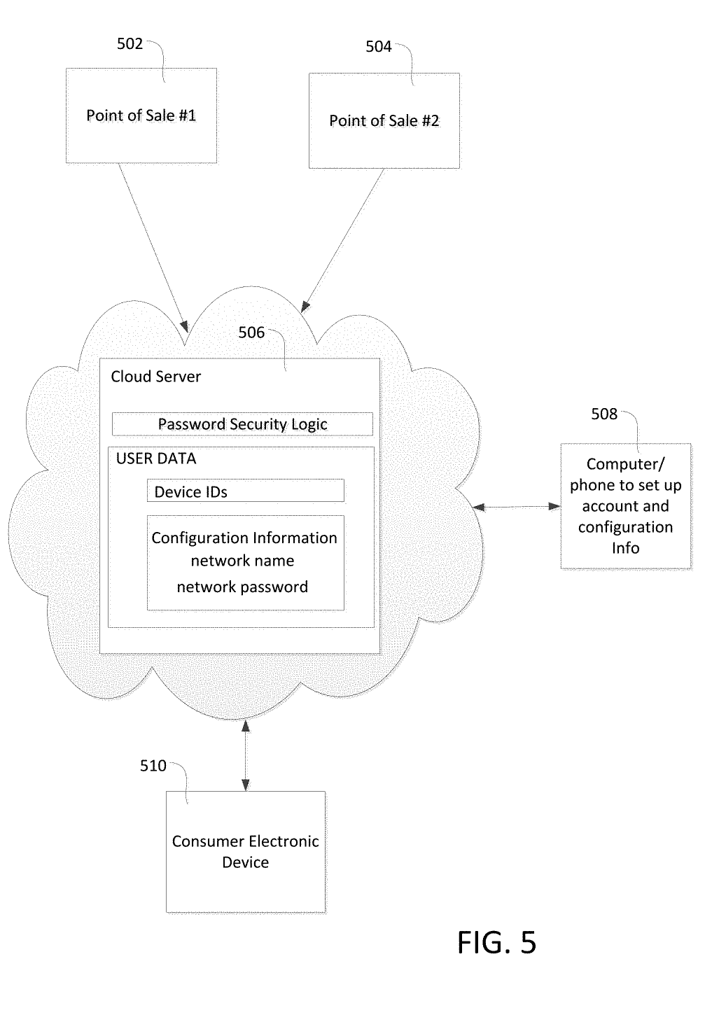

FIG. 5 illustrates an example embodiment of a system for automatic configuration of a device. Device 510 can be pre-provisioned/configured at point of sale locations 502 and 504, such as a retail location or a web site. A device ID can be provided to a cloud-based service from the point of sale locations 502 and 504.

The device ID can, for example, be produced or generated by the manufacturer or the retail store. The device ID can include or be associated with a serial code value that uniquely identifies the specific product that is sold. For example, the device ID can be some combination of a product code, company code, and a serial code that identifies a specific product. For example, a store code can be combined with a serial code or a product code can be combined with a serial code.

The device ID can be stored in a memory of the device. In one example, the device ID can be preloaded into the device. At the point of sale location, the device ID can be read from a box or a sticker, manually or automatically using a reading mechanism.

The point of sale location 502 or 504 can associate purchaser information with the device ID for device 510. For example, credit card information or other data can be linked with a purchaser and used to look up the purchaser's account.

In one example, configuration information for the device can be provided through the user's associated cloud-based account to the device's cloud-based provisioning and configuration account. When the device 510 is powered up, the device can pull provisioning and/or configuration information from the associated cloud cloud-based which can be identified by the unique device ID.

Configuration information can be generated automatically or provided by the user and sent to the provisioning cloud-based account. The configuration information can be associated with a user's account at the point of sale location 502 or 504 or from a separate device 508 such as a PC, laptop, tablet, or phone. The configuration information can be associated with a specific user ID and a set of one or more device IDs.

As discussed above with respect to FIG. 3, device 510 can be securely provisioned via a cloud-based service through an open network connection using a unique device ID. Each device can have an associated configuration account in a cloud-based service via the unique ID. The device configuration account can be associated with a user's cloud-based account for the purpose of providing configuration and provisioning data. The device 510 can automatically connect to its cloud-based configuration account through its unique device ID and can pull configuration information at first power-up of the device.

At initial power up, the device 510 can connect to the known configuration cloud-based service. By identifying itself with the device ID, the device 510 is able to obtain the user-specific configuration information associated with it.

This enables the use of any available internet connection for provisioning and configuration of a device against user-specific configuration information including but not limited to low power mesh commissioning, application and cloud configuration information, and wireless network configuration information.

The disclosed embodiments can be used for low power mesh commissioning (e.g., thread). With a unique thread network stored in the cloud, a device can be instructed to configure itself to join that specific thread network. Likewise, a thread network commissioner can obtain the device IDs associated with the network and automatically commission those devices. This can allow for an automatic and secure way of commissioning a device to a user's low power mesh network. This can be suitable in situations where there are multiple overlapping networks such as in a compact residential area.

The disclosed embodiments can be used for application and cloud configuration information (e.g., application of authentication tokens and provisioning against an application cloud). By calling up to a known configuration server with its device ID, a device can obtain any configuration information supplied by the user. When applicable, this could include authorized tokens for communication, as well as information about application endpoints (e.g., a cloud IP or URL) that can be used. This can allow for an automatic and secure way of configuring applications on a new device without the need for specific user input after the point of sale exchange.

The disclosed embodiments can be used for wireless network configuration information (e.g., information about a home network and the network to use). By calling up to a known configuration server with its device ID, the device can obtain network credentials and information about which network to connect to (e.g., SSID and Frequency) in order to be active and operational on a user's WiFi network at unboxing time. By implementing the described techniques, new setup or interaction steps from the user may not be required after the point of sale exchange.

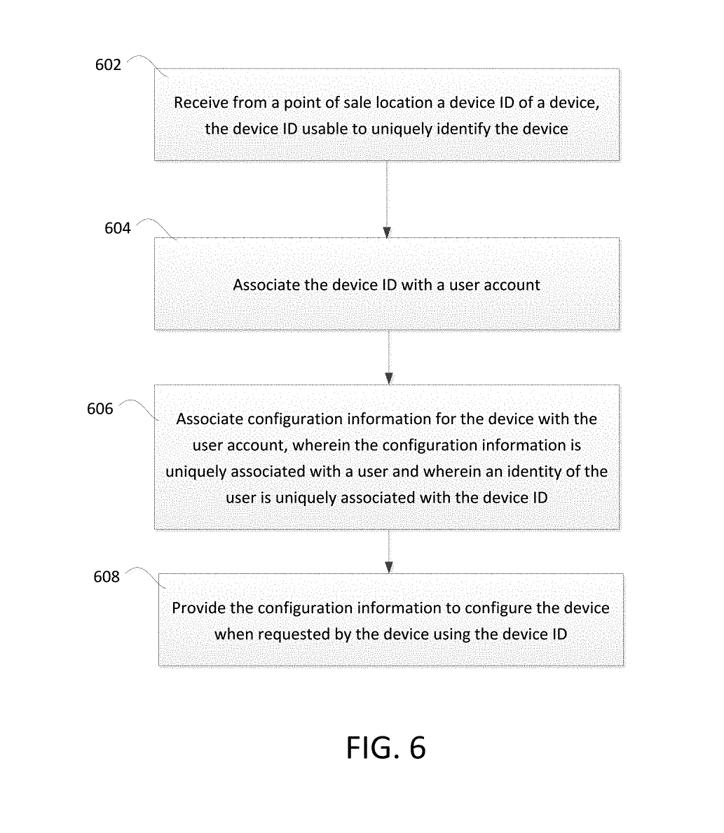

FIG. 6 is a flow chart that illustrates operation from the viewpoint of a cloud-based server or cloud-based service.

In step 602, a device ID of a device is received from a device transaction point, such as a point of sale location. The device ID can be usable to uniquely identify the device.

In step 604, the device ID is associated with a user account.

In step 606, configuration information for the device is associated with the user account. The configuration information can be uniquely associated with a user and an identity of the user can be uniquely associated with the device ID. The configuration information may be usable to configure one or more of security, network access, and information access settings for the device. Step 606 can be done before or after step 604.

In step 608, the configuration information is provided to configure the device when requested by the device using the device ID.

It should be appreciated that any software components described herein may, when loaded into a processor and executed, transform the processor from a general-purpose computing system into a special-purpose computing system customized to facilitate the functionality presented herein. The processor may be constructed from any number of transistors or other discrete circuit elements, which may individually or collectively assume any number of states. More specifically, the processor may operate as a finite-state machine, in response to executable instructions contained within the software modules disclosed herein. These processor-executable instructions may transform the processor by specifying how the processor transitions between states, thereby transforming the transistors or other discrete hardware elements constituting the processor.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture in order to store and execute the software components presented herein. It also should be appreciated that the architecture may include other types of computing devices, including hand-held computers, embedded computer systems, smartphones, PDAs, and other types of computing devices known to those skilled in the art. It is also contemplated that the architecture may not include all of the components shown in the figures, may include other components that are not explicitly shown in the figures, or may utilize an architecture completely different from that shown the figures.

Alternatively, or in addition, the functionally described herein may be performed, at least in part, by one or more hardware logic components. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Computer-readable storage media may provide storage for instructions for the one or more processors. Although the description of computer-readable storage media contained herein refers to a mass storage device, such as a hard disk or CD-ROM drive, it should be appreciated by those skilled in the art that computer-readable media may be any available storage media.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which may be used to store the desired information and instructions. For purposes of this specification and the claims, the phrase “computer-readable storage medium” and variations thereof, does not include waves, signals, and/or other transitory and/or intangible communication media.

Although the subject matter presented herein has been described in language specific to computer structural features, methodological and transformative acts, specific computing machinery, and computer-readable storage media, it is to be understood that the methods and devices defined in the appended claims is not necessarily limited to the specific features, acts, or media described herein. Rather, the specific features, acts, and mediums are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the technology be defined by the claims appended hereto.

What is claimed:

1. A method for provisioning an Internet of Things (IoT) device that is connectable to a network, the method comprising:
receiving, via a device transaction point, data indicative of a device ID, the device ID uniquely identifying the device;
associating the device ID with a user account;
associating configuration information for the device with the user account, wherein the configuration information is uniquely associated with a user and wherein an identity of the user is uniquely associated with the device ID, and wherein the configuration information is usable to configure one or more of security, network access, and information access settings for the device; and
providing the configuration information to configure the device when requested by the device using the device ID.

2. The method of claim 1, wherein the configuration information includes a wireless network ID and password.

3. The method of claim 1, wherein the device transaction point is a point of sale location.

4. The method of claim 1, wherein the device uses the configuration information to establish a connection to a wireless access point.

5. The method of claim 1, wherein the device obtains the configuration information during an initial power-up sequence of the device.

6. The method of claim 1, wherein the configuration information is stored at a server.

7. An apparatus comprising a processor and a memory, the apparatus further comprising computer-executable instructions stored in the memory of the apparatus which, when executed by the processor of the apparatus, cause the apparatus to:
receive, from a first device, data indicative of an acquisition of a second device, the data including a device ID of the second device, the device ID usable to uniquely identify the second device;
determine, based on the data, a user ID associated with the acquisition;
associate the device ID with the user ID;
determine configuration information for the second device based on the device ID and the user ID, wherein the configuration information is uniquely associated with a user based on the user ID, wherein the user ID is uniquely associated with the device ID, and wherein the configuration information is usable to configure one or more of security, network access, and information access settings for the device; and
provide the configuration information to configure the second device when requested by the second device using the device ID.

8. The apparatus of claim 7, wherein the configuration information includes a wireless network ID and password.

9. The apparatus of claim 7, wherein the device is a consumer electronic device.

10. The apparatus of claim 7, wherein the device uses the configuration information to establish a connection to a wireless access point.

11. The apparatus of claim 7, wherein the device obtains the configuration information during an initial power-up sequence of the device.

12. The apparatus of claim 7, wherein the apparatus is a cloud server.

13. A system comprising a processor and a memory, the memory storing thereon computer-executable instructions stored in the memory of the system which, when executed by the processor of the system, program the system to:
receive data indicative of a transfer of ownership of a device, the data including a device ID of the device, the device ID usable to uniquely identify the device;
determine, based on the data, a user ID associated with the transfer of ownership;
associate the device ID with the user ID;
determine configuration information for the device based on the device ID and the user ID, wherein the configuration information is uniquely associated with a user based on the user ID, wherein the user ID is uniquely associated with the device ID, and wherein the configuration information is usable to configure one or more of security, network access, and information access settings for the device; and
provide the configuration information to configure the device when requested by the device using the device ID.

14. The system of claim 13, wherein the configuration information includes a wireless network ID and password.

15. The system of claim 13, wherein the device is a consumer electronic device.

16. The system of claim 13, wherein the device uses the configuration information to make a connection to a wireless access point.

17. The system of claim 13, wherein the device obtains the configuration information during an initial power-up sequence of the device.

18. The system of claim 13, wherein the apparatus is a server.

19. The system of claim 13, wherein the data indicative of a transfer of ownership is received via a point of sale device.

20. The system of claim 19, wherein the user ID is determined based on point of sale data.
